(19) United States
(12) Patent Application Publication
(10) Pub. No.: US 2002/0091712 A1
(43) Pub. Date: Jul. 11, 2002

(54) Data-base caching system and method of operation

(76) Inventors: Andrew Richard Martin, Austin, TX (US); Alan Eric Arvesen, Austin, TX (US)

Correspondence Address: WILSON SONSINI GOODRICH & ROSATI, 650 PAGE MILL ROAD, PALO ALTO, CA, 943041050

(21) Appl. No.: 09/843,993

(22) Filed: Apr. 27, 2001

Related U.S. Application Data
(60) Provisional application No. 60/244,058, filed on Oct. 28, 2000.
(60) Provisional application No. 60/244,066, filed on Oct. 28, 2000.

(51) Int. Cl. G06F 12/00

(52) U.S. Cl. 707/200

(57) ABSTRACT

A method and apparatus (10) is used to allow data within a database system to be cached in local cache memory (30) without requiring significant changes to surrounding software and systems, such as applications (12), native drivers (18-22) and database backends (24-28). To do so, a virtual driver (16) is coupled between the backend systems (24-28) and one or more applications (12). When the driver (16) receives a query from the application (12), the driver (16) processes the query to determine if the query is to be processed using cached data from local cache (30), backend data from databases (24-28), or a combination thereof. If cached data is needed, the driver (16) will usually alter or modify the query and/or information associated therewith to ensure that the cached data is properly accessed and used instead of the backend database information. Caching in this manner is likely to ensure one or more of significant improvements in data transfer performance and/or a reduction in database server loading.

### CLAIM OF PRIORITY

This application claims the benefit of priority under 35 U.S.C. § 120 to the provisional application serial No. 60/244,058, entitled, “Improved Methods of SQL Query Caching Using Cache Arrays”, filed on Oct. 28, 2000 and provisional application serial No. 60/244,066, entitled, “A Virtual JDBC Driver And Method Of Extending JDBC API Calls Without Extending Multiple Drivers”.

### FIELD OF THE INVENTION

The present invention relates to an apparatus and method for intercepting and changing database instructions and information flowing between a back end system and a front end system to enable caching of select data, this caching improving the average data access times for the data-base by orders of magnitude.

### BACKGROUND OF THE INVENTION

At the core of most e-business and computer systems lies a structured query language (SQL) database or SAG SQL database, which provides for: a place to store data across an enterprise; easy backup and recovery of the data; accessibility of data across the enterprise; a query language that is particularly suited for creating reports on all aspects of a given system and the data it contains in main databanks; extensive data and system security features; software to enable multiple views of the same data set; and a combination of very complex software and system solutions that render the data useful to end users. Obviously, these databases are large and complex, and therein lies many problems with modern database systems. For example, one problem with these databases is that their size and complexity almost always ensures that the system will be slow to create a connection between the end user computer and the backend databases. In addition, the data system will be slow to run queries once connected, and the system will only be able to handle a limited number of connections at any one time (the bandwidth is likely to be limited). In spite of these limitations, most web-based systems require high performance and enhanced speed of access. In fact, high performance and speed become even more critical as data expands, since the applications are still expected to still achieve sub-second response rates for their users. Fast response times become even more critical once the system begins to scale to larger data repositories, scales to more servers or networks over time, experience bandwidth limitations, or is changed to add more end users to the system. In most cases, the complexity and size of the database platform itself serves as a hindrance to the goals of fast access, improved bandwidth, and reduced response times, which is why system designers turn to customized, costly and complex database caching implementations for caching operations within their systems.

In order to increase performance of relational database systems or SQL systems, the systems are usually custom modified to store or cache results from the database in local memory closer to the end application. However, in order to enable such caching in database systems, access to the source code of all or most of the drivers, database software, application programming interfaces (“APIs”), and applications is often needed. In many cases, an end user does not have access to such source code, and even with such access, these source code changes would be complex, time-consuming, costly, and significant in magnitude (e.g., requiring significant post-installation system testing and IT overview). In many cases, companies do not even have application servers in their control, which means that in order to employ caching, custom code must be created and deployed by others at great expense and lost time. Further, once these source code changes in the APIs, applications, driver, backend, SQL, etc., are made, compiled into object code, installed, tested, and deployed, any subsequent changes in the applications, back-end software, applications, APIs, etc., may require that these caching source code changes be made all over again or at least significantly overhauled to accommodate the now-changed system. In other words, custom code is specific for each application; as the applications change, so must the caching code.

By using this customized, source-code-based, development-intensive approaches, many application servers and e-business platforms from such vendors as ATG, Blue Martini, IBM, and Vignette can provide their own proprietary forms of caching. However, this customized form of caching in database systems suffers from drawbacks over and above the overhead, cost, and customization complexity set forth above. First, caching that is implemented in one third-party application or application server will generally not work along with another application or server. In the best case, the user must maintain independent caches of the same data for different servers and/or applications which increases IT support, infrastructure costs, complexity, implementation times, downtime, etc. In the worst case, the end user is unable to cache large amounts of data when using certain applications or when retrieving data from certain servers, whereby full access to the slow database is required in many cases without any of the benefit of the caching. In addition, most application servers or platforms provide only a limited form of caching. In these systems, some types of data can be cached and some types of data cannot. Since caching techniques are often complex and require a number of different approaches depending upon the structure of the data, some data is not cached at all since the caching algorithm is too limited, too narrowly tailored, or too old to process all data now present within the system. In most cases, there are no tools to manage the cached data or to query the caches, since these tools are difficult to integrate into the customized source code system.

Therefore, the industry needs a database caching system and method that is more cost-effective, more flexible, easier to deploy and maintain over time, and that provides improved performance benefits over existing customized and inflexible caching solutions.

### BRIEF DESCRIPTION OF THE DRAWINGS

FIG. 1 illustrates, in a flow diagram, an apparatus and method for caching local information within a static data system.

FIG. 2 illustrates, in a block diagram, an apparatus and method for processing JDBC requests and storing certain request parameters which the system can use later to make a backend database connection if required due to a cache miss or a need to access the backend database.

FIG. 3 illustrates, in a flow diagram, a method for an API call uses a stored handle to a native JDBC driver to make a call to its own native method or API and then to display the result.

FIG. 4 illustrates, in a flow diagram, how an example API call ignores the handle associated with a native JDBC driver and returns a local cached value without need for accessing the native driver.

### DETAILED DESCRIPTION

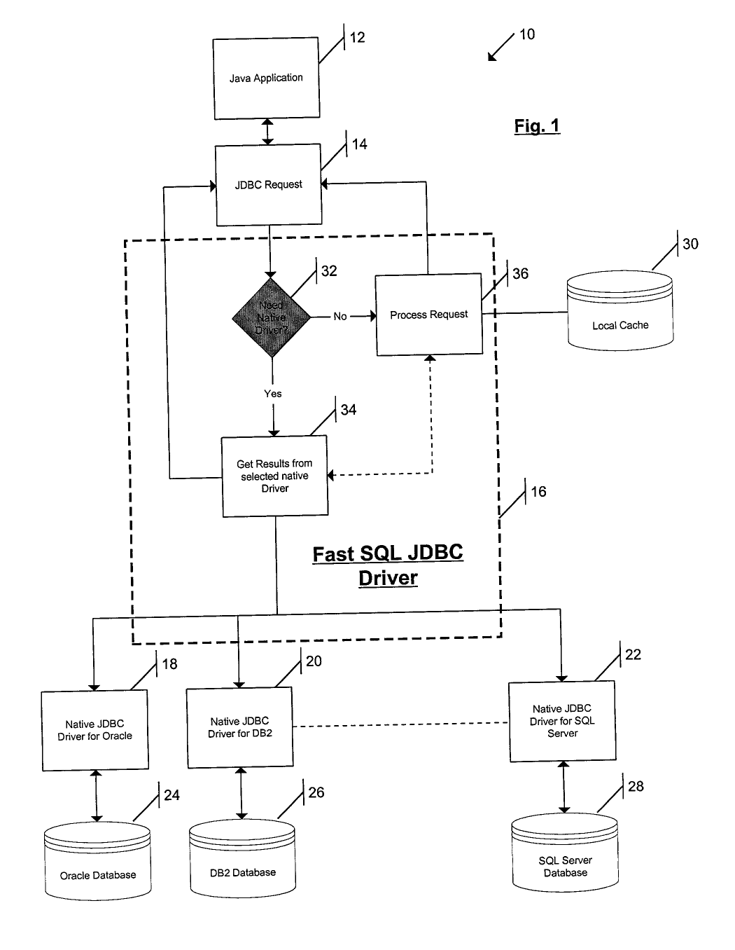

A new approach, discussed in more detail with specific reference to FIGS. 1-4 below, involves the creation of a Virtual JDBC Driver, also referred to as the FastSQL JDBC Driver. This Virtual JDBC Driver is a software driver that is inserted between the front end applications and APIs and the backend systems (e.g., the drivers and database). The Virtual Driver is designed to interface and function along with all existing native drivers within all existing and deployed database systems. The Virtual JDBC Driver is a driver that provides the same interface to a Java client or application as a Standard or Native JDBC Driver. The FastSQL JDBC Driver is preferably not an extension of an existing Driver, but rather is code that sits on top of all the native drivers and supports all 22 classes and 600+ method calls of the known Native JDBC Drivers.

In the majority of cases, the methods in the Virtual JDBC driver simply call the methods of the Native JDBC Driver that supports the Database whereby the Virtual JDBC Driver is simply a conduit from the front end applications and APIs to the Native Drivers and the backend. In these cases, the Virtual Driver is transparent to the function of the system and the system performs normal database queries as though the Virtual Driver were not present at all. However, the Virtual JDBC Driver may be programmed to intercept queries and data moving between the backend databases and the front end applications, in order to provide and store data to a cache location. The Virtual JDBC Driver may also trace calls or rewrite queries to make them more efficient for caching algorithms implemented within the system. When content for a query is cached by the system, the Virtual Driver may never call any of the methods of the Native JDBC Driver (i.e., in some caching-enabled cases, the Virtual Driver will become the full driver with no need to rely on the native drivers or the backend data). With the Virtual Driver, the performance characteristics of a JDBC based system may be enhanced without having to build a custom cached-enabled native driver for all data sources, and of course without having to make changes to the source code of the application, back-end software, or the Database system itself. Therefore, this Virtual Driver solution will generally be more cost-effective, easier to deploy, require less overhead, and enable better data access and system performance, and/or generally be improved over source code customized caching operations set forth above.

More specifically, FIGS. 1-4 illustrate a system and method whereby all API calls from any Java application that use the JDBC API to access a Relational Database or SQL Database can be extended for effective caching without having to significantly rewrite the application, the APIs, the native drivers, the database, backend code, etc. The Virtual Driver will easily plug and play with an existing deployed system so that a system that has no caching or limited caching ability can be upgraded quickly, and cost-effectively. The present invention method is used with Java 2 Standard Edition (J2SE) and JDBC 2.0 but is applicable to all versions of Java, JDBC, or other e-commerce software languages. Any Java application that uses JDBC can be used to exercise the program of the preferred embodiment (called “FastSQL JDBC Driver”). In the preferred embodiment a Java Application makes calls to the FastSQL JDBC Driver which then returns results to the application. If necessary, the FastSQL JDBC Driver will load and execute calls to a Native JDBC Driver to execute the query for the end user.

FIG. 1 illustrates a Java computer system structure/network 10 from a functional, control flow, and/or software point of view. Referring to FIG. 1, a Java Application 12 that is executing on a client computer makes a request to the JDBC API via a Request Procedure or Request Software 14. Note that the Application 12 and any application programming interfaces (APIs) associated therewith can be any type of one or more software programs that are stored on computer readable memory or medium (i.e., SRAM, DRAM, EEPROM, CDs, magnetic tape or disk(s), optical storage, etc.) and resident and eventually executed on a computer, central processing unit (CPU), microcontroller, hand-held device, phone, mainframe, server, or like computing device.

This Request Software 14 provides the Request from the Application 12 to the FastSQL Virtual JDBC Driver 16. Driver 16 is also software that, in a preferred form, runs on the same computer as the application and APIs however, in other embodiments, the Driver 16 may reside and/or execute on another computing device coupled to the client application computer. Within the Virtual Driver 16, software and/or hardware determines the needs of the query submitted by the application. In some cases, only the Native Driver Software and Interface 34 may be needed in order to perform that query in full. For example, if the query is accessing data that is tagged as not being available for caching, is not in the cache, or is entirely resident on the databases 24-28, then the Virtual Driver 16 will determine through tag bits and table look-ups that the request cannot be processed locally in Local Virtual Driver Portion 36 using local cached data and Cache 30. In these cases, the Local Driver 36 is not invoked, and the query is processed as a normal query through Native Drivers 18-22 code via Native Driver Connection Code 34. In these cases, the Driver 16 is merely a conduit through which the system illustrated in FIG. 1 will operate in a native fashion without interference from the Driver 16.

In other cases, the Code 32 will detect that local caching may have occurred in whole or in part and route the query to the Local Driver Code 36 for query processing. In the cases where the query processes or needs only data within the Local Cache 30, only the Local Driver 36 is executed and the query may be processed using only the Local Driver 36 and not the Native JDBC Driver Code 34. In some cases, caching may be possible and the Code 32 will invoke execution of the Code 36 only to find that the cached information is old (i.e., has been tagged as dirty due expiration of time or has been changed in main memory), results in a cache miss, or may have been cycled out by a replacement algorithm in the Local Cache 30. In these cases and other cases, both the Code 36 and the Code 34 is needed to process the query.

Other cases where both Code 36 and Code 34 is needed is when a query has part of the data it needs located in the Local Cache 30 and another part of the requisite data in one or more of the data-bases 24-28. Note that the databases are generally very large, and complex server systems and arrays of storage devices that maintain, store, and manage large quantities of data whereby it is not unusual for a query to draw from multiple servers or caches. In some cases, the cache 30 may be split into multiple layers or hierarchies of cache that trade size and speed in a hierarchical manner (i.e., level 1, level 2, and level 3 cache). Therefore, the Control Code 32 is used to determine, on a query-by-query basis from the API/application, or based upon some other criterion like the computer source of the query, whether or not the Code 36, the Code 34, or both Programs 34 and 36 are needed to process the query from the client or end user.

In order to render processing of queries in a much improved and pipelined manner, the Software 32 may assume at first that the query will require both the Local Cache and the backend databases 24-28. With this assumption, the Driver 16 will begin to process the query or set up the settings and state of the machine that is needed to enable both of the paths 34 and 36. Such will be configured within the Driver 16 without actually connecting to the Local Cache 30 or the Drivers 18-22 since it is not yet know if these resources are needed (the Program 32 is making this determination in parallel to the Code 34 and 36 preparing for either decision). Once the Code 32 determines which of the two Processes 34 and/or 36 are needed, then the proper connections are made and the query processed as needed. If one or both of the Programs 34 or 36 were determined not to be needed, then that configuration or initial setup done by the system can simply be cancelled or overwritten by the next query process.

If a determination is made by Software 32 that a backend connection and access is needed, the Driver 16 passes the request/query in whole or in part to one of the available drivers 18, 20, and/or 22. Those portions of the query are then processed in the slower database storage structures 24-28. The results are retrieved from the selected database 24, 26, and/or 28 when there is no caching and from the faster Local Cache 30 when cached content is found. Once we have the accumulated result of the query we pass the result back to the FastSQL JDBC Driver 16 which in turn subsequently passes the result(s) back to the original JDBC Request Construct 14 for use by an end user.

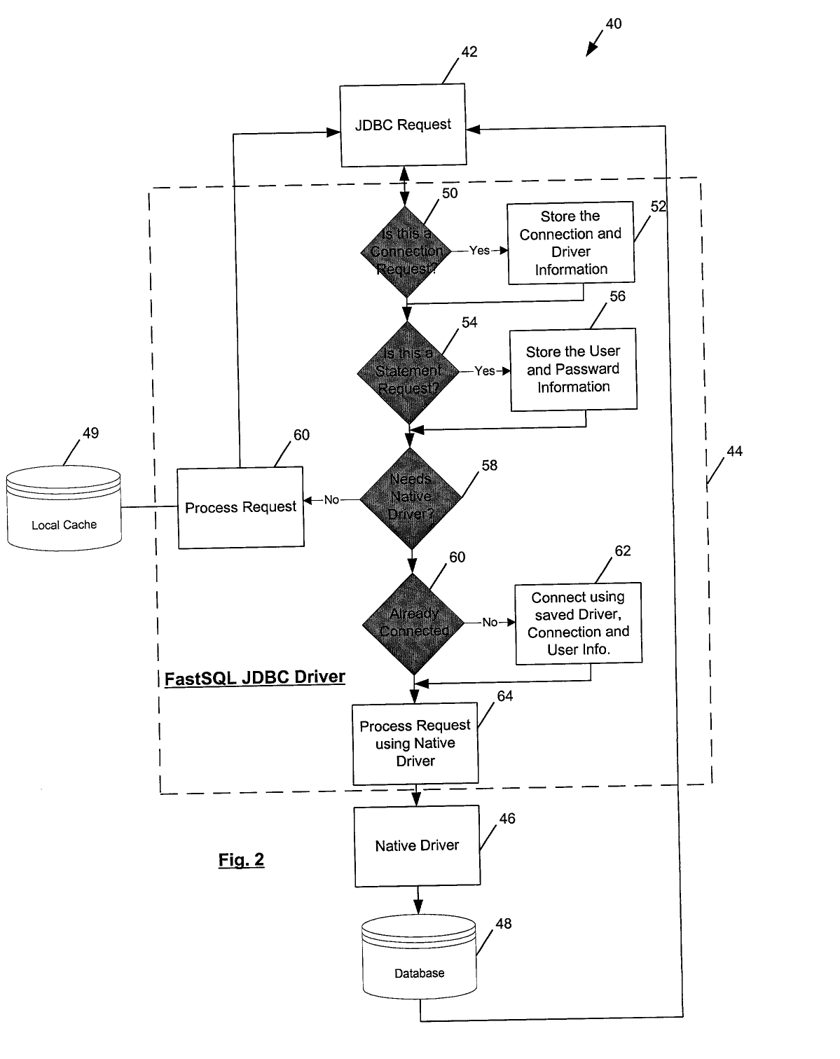

FIG. 2 shows another embodiment of a database system or network 40 that may be used to implement a slightly different process within the Virtual FastSQL JDBC Driver 44 when compared to the system 10 of FIG. 1. The system of FIG. 2 generally enables more efficient pipelining of query transaction and better resource utilization, in some applications, than that observed for the system and method of FIG. 1. In FIG. 2, a JDBC Request 42 is passed to the FastSQL JDBC Driver 44 by an end user's computer system. If the request is a Connection request (getConnection) to the database backend(s) 48, the Code 50 determines this is the case within the Driver 44. In the event of a getConnection query, instead of connecting to the Database Backends 48 at that time, the system 40 stores the parameters required for the call via Software Code 52 and returns a virtual connection back to the request 42 so that the end user computer can assume that a connection has been created. If the request is a statement request (createStatement), such a request is detected by the Code 54. In the event of detection of a createStatement query, instead of creating the statement at that time, the System 40 stores the information about the user, originating system, and password via Code 56 in local registers or memory and returns a virtual statement back to the request 42. In alternative embodiments it is quite likely that additional, different, or other data other than the data stored in steps 52 and 56 will be stored as may be required for different applications or systems. If the request is neither of a createStatement or a getConnection, then the system generally does not store any local data related to the request from the user.

In FIG. 2, if the Driver 44 detects that the system can process the request without the aid of a native driver via Code 58, then the entire query is processed with Local Driver Code 60 in order to access Local Cache 49. If possible, the entire request is processed through Cache 49, and all results are passed back to the Requesting Computer 42 by the Driver 44. If access is needed to the slower back end database, then code 58 will ensure that code 60-64 is executed either along with or without execution of Code 60 (as required). Code 60 checks to see if the Driver 44 has an existing active connection with the backend Native Driver 46 and the Database 48 that is needed for the current query. If the System 40 has not connected to that backend system, then the Driver 44 retrieves the saved data from computer memory (e.g., the storage area for Programs 52 and 56 are access to retrieve requisite connection, driver, user, password, and other information) and then the Driver 44 connects to the Database 62. This connection to the database is stored or cached via Code 62 to enable future connections to that database in a fast and efficient manner. Once the connection is made, Code 64 uses the Native Driver 64 to process, in whole or in part, the query with the Native Driver 46 and the Database(s) 48. The request is processed over the connection using the Native JDBC Driver 46 and retrieves the required results from the database 48. The Driver 46 returning the results through the FastSQL JDBC Driver 44 back to the requesting system that provided the Request 42. At that time, the connection to the backend systems can be disconnected so that static connection to the back end system is not maintained when not in use. This dynamic method of connection to the backend systems can free us back end resources to service more requests and better allocate bandwidth than prior art system that have no caching or poor chaching and therefore generally maintain a static connection to backend systems.

The process of FIG. 2 is improved in some ways over the process of FIG. 1 since the local registry of connection info via Code 52 and 56 enables more effective pipelining of requests and improved throughput of the system through the Driver 44. Also, connections to the slower backend database 48 are only made when absolutely necessary. Further, if a connection to a backend system is needed and was accomplished before, the cached connections per Code 62 allow connections to be made faster and more effectively on an “as needed” basis.

As an example of the benefit of the structure set forth in both FIG. 1 and FIG. 2, if the system is configured so that the Virtual Driver is being utilized in the system only to perform a certain type of tracing of all objects, database accesses, and methods, then the system of FIG. 1 would be used since the system would not need to delay the connection to the backend systems at all. Since these applications can real-time determine if a connection is needed and quickly enable and maintain that connection for long periods of time, the system does not need to store the information of stored by Software 52 and 56 of FIG. 2. For situations in which we are trying to minimize the number of connections to a database due to the presence and enablement of caching in a Local Cache 49, the system of FIG. 2 would be used. The system 40 of FIG. 2 is used since it is beneficial to delay back end connections, determine if cached data is present, use cache data when present, and also cache results locally for later us without activating the backend connection so that the Virtual Driver does not waste backend connections and resources when the query can be completed by entirely or largely relying on Software 60 and Local Cache 49.

Generally, the FastSQL JDBC Drivers 16 and 44 taught herein are designed to ensure that all objects that are returned by these Drivers point to the Virtual Driver's own classes/routines rather than the Native JDBC Driver's class objects. If this change of control of the primary driver from a Native Call to a Virtual Call is not made when a query is started, then the objects/processes that the system will not exhibit the extended caching or performance monitoring behavior. If the queries and responses are not change to “point” to the Virtual Driver, they continue to be calls to the Native JDBC Drivers directly and the query will not know that the Drivers 16 and 44 exists and are to be accessed to properly perform the query with performance-enhancing cached data. By way of example, the table below displays the class objects that need to be returned by the system when a JDBC API calls return an object of a certain class. This table shows that native driver calls are changed to “point to” or identify the Virtual Driver as the main driver for that query from that time forward.

| JDBC API Returns | Return our FastSQL FS |
|---|---|
| Object | Driver Objects |
| Array | FSArray |
| Blob | FSBlob |
| CachedResultSet | FSCachedResultSet |
| CachedResultSetMeta | FSCachedResultSetMetaData |
| Data | |
| CallableStatement | FSCallableStatement |
| Clob | FSClob |
| Connection | FSConnection |
| DatabaseMetaData | FSDatabaseMetaData |
| Driver | FSDriver |
| PreparedStatement | FSPreparedStatement |
| Ref | FSRef |
| ResultSet | FSResultSet |
| ResultSetMetaData | FSResultSetMetaData |
| Statement | FSStatement |

Because each FastSQL JDBC Driver contains a handle to its Native JDBC Driver counterpart, it is always possible for the referenced Virtual Driver to pass through queries and sub-tasks of a query to the Native JDBC Drivers 18-22 or 46 by making calls to the FastSQL JDBC Drivers 44 and 46. However, since the native drivers are used in an unchanged or substantially unchanged state, the native driver does not know that the newly added Virtual Driver exists and cannot determine if the Virtual Driver is needed and cannot route queries to that Virtual Driver whereby the caching taught herein could not occur unless significant source code changes were made to the native drivers (a process that FIGS. 1-2 seeks to totally avoid or at least significantly reduce). In short, it is generally not possible for a call to the native drivers to route those calls in whole or in part to the Virtual Drivers 44 and 46 for query processing, but the reverse is possible. Therefore, calls/objects are changed by the Virtual Driver up front to ensure that the Virtual Driver is the conduit by which Local Drivers or Native Drivers are selected when processing a query within the systems of FIGS. 1 and 2. If calls are not directed to the Drivers 44 and 46, extended caching behavior cannot be effectively performed within the system.

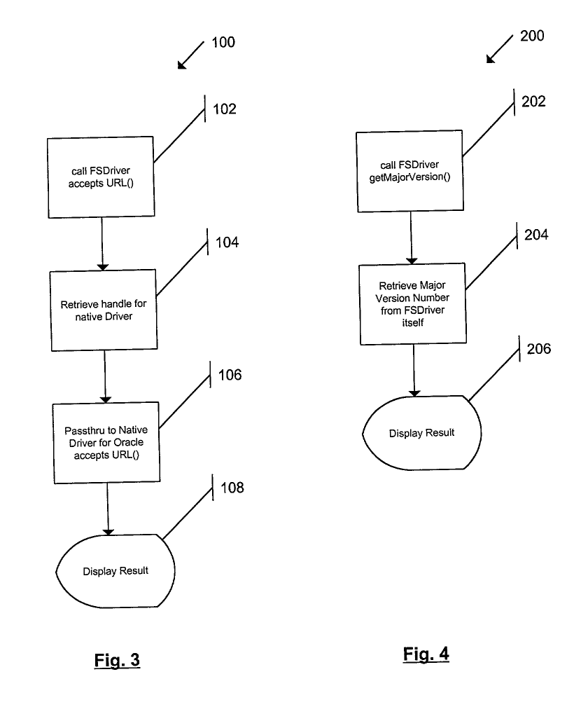

FIG. 3 illustrates a method 100 showing how a JDBC API call is processed in a FastSQL JDBC Driver when native driver methods need to be utilized. In other words, FIG. 3 illustrates how the Drivers 16 and 44 of FIGS. 1 and 2 process API calls within a database system when the Native Drivers are needed. In FIG. 3, a JDBC API call is made to the FastSQL JDBC Driver in a step 102. The example of FIG. 3 is specifically showing what happens when an acceptsURL( ) API call is originated, but any other API call would be processed in a similar manner if Native Driver code is needed. When an API call is made, the system needs to get the handle or contact information of the Native JDBC Driver from local storage, and such information is obtained in step 104. Using the handle, the Virtual Driver accesses the Native Driver and backend database information is obtained, This information is obtains since the driver passes through, in whole or in part, the acceptsURL( ) call to the native driver via a step 106 and receives the results back from the backend. Once the call is completed with the backend systems in step 106, the system displays the end result at the user computer per the step 108.

FIG. 4 illustrates a method 200 for making a different API call within the system, where native driver code is not required at all. Referring to FIG. 4, a JDBC API call 202 is made to the FastSQL JDBC Driver per a step 202. This example illustrates what happens when a getMajorVersion( ) API call is originated, but any other Cache-only call could will use the same process. In step 204, it is determined that the API call references/needs a local method or local process within our virtual driver, since it refers to the FastSQL JDBC Driver itself. In this case there is no need to call a Native JDBC Driver method, but instead the system retrieves its own internal Major Version Cache Number and displays the resulting data/information to the end user in step 206 via the application.

There are several benefits to using the Virtual Drivers 16 or 44 in database systems as discussed herein. For example, since the backend database servers are extremely complex and contain significant amounts of data, their access times are very slow. However, the access time, interconnection, and physical proximity of the Local Caches 30 and 49 will ensure, in most cases, at least a 10× improvement in query processing time and/or a 10× decrease in the load experienced by the server. Depending on the query, however, results can be dramatically more than a 10× improvement in performance. For example, tests and simulations performed on some database systems that generally execute large queries on a steady basis have determined that the caching taught herein may improve query speed by a factor of 1000 or more. As an example of these tests, the table below shows a set of test queries were performed both using the Virtual Driver (FastSQL) and using a fine-tuned Oracle database system. The Virtual Driver (FastSQL) of FIGS. 1-4 was found to provide at least 100× improvement in performance over the Oracle system in most cases.

Long queries, multiple tests at once, timings in seconds

| | | | Improvement |
|---|---|---|---|
| | FastSQL | Oracle | Factor |
| | 18.30 | 2,247.16 | 122.8 |
| | 18.89 | 3,725.06 | 197.1 |
| | 18.36 | 3,726.63 | 202.9 |
| | 19.44 | 3,72244 | 1936 |
| | 20.38 | 3,72362 | 182.6 |
| | 19.38 | 3,72342 | 192.0 |
| | 20.17 | 3,72245 | 184.5 |
| | 19.48 | 3,720.50 | 190.9 |
| Average | 19.30 | 3,538.27 | 183.0 |

Naturally, very fast queries or queries that are short to execute but occur with greater frequency may not see significant speed/performance enhancements to the level shown in the table above. In these cases, the overhead of caching, tag lookup, hit/miss processing, connection creation, dirty bit comparisons, etc., are a large part of the overhead of the transactions and the data transfers from Cache and database backends begin to converge a bit. However, when caching is used in these system, the system usually experiences some speed improve and does allow from greater system scaling since the caching almost always reduces the load on backend database servers.

In addition, FastSQL Virtual Cache Drivers can be deployed in many operating systems and databases, so end users only have to deal with one release of the Virtual Driver across all of their platforms, applications and native drivers. This portability of the Virtual Driver is accomplished since this software is, in a preferred form, written 100% in Java. In Java, the Virtual Driver can support multiple Operating Systems, multiple Database vendors, and multiple application servers at the same time without significant need for customization or change.

Third-party caching solutions or custom caching solutions tend to be difficult to use and require custom coding efforts, resulting in limited use and flexibility in the system caching model. The system and methods taught herein employ simple and virtual interfaces, which are used to monitor candidate queries for caching as queries are executed, and then implement the data caching. All this functionality can be accomplished with little or no custom code, no modifications to the application, and no specific high-level caching expertise. The FastSQL Software 16 can identify and monitor the hot spots or bottlenecks of a live system over time and suggests ways to enhance system performance as the system changes due to changes in the data, in the system, arrangement of data, size of data tables, etc. These self-improvement or diagnostic functions within the Virtual Driver are done without ever having to go back to the original application team. A failing of conventional caching schemes is that they are created and tuned specifically for a given data set, and as the data changes over time this caching can quickly become inadequate. When compared to the originally deployed database system, the FastSQL solution taught herein does not require significant additions of more hardware/software.

Existing database system are significantly dependent upon large quantities and interconnections of storage devices, communication lines, computers, servers, routers, load balancing devices, and other types of hardware and software. As the systems taught herein scale and employ more and more caching, FastSQL will, in many cases, reduce the need for additional hardware (e.q., data-bases, servers, load balancers, etc.) and software licenses (i.e., custom changes to APIs, applications, back end code, etc.). These reductions are due to the fact that bandwidth to the backend is not consumed as fast when deploying a Virtual Driver FastSQL solution and the APIs, applications, back end code, etc., stay substantially the same after addition of the Virtual Drivers. In fact, thee bandwidth requirements of the backend may actually be reduced over time in the system, even as the system scales to more data and/or database files.

Generally, the methods described herein can be enabled as illustrated in FIG. 1 and FIG. 2 with the objects 12, 14, and 16 (and optionally the native drivers 18-22) residing on one or more client computers. In addition, the Drivers 18-22 (optionally) and the database files 24-28 may reside on one or more server computers coupled by a wireline or wireless network to the client computers. In one or more client computers, the Driver 16 is designed to seamlessly intercept queries/calls to the database(s), in order to decide to trace the call (to monitor system performance and optimize caching), rewrite the call to enable caching, retrieve the call's results from the cache, or pass the call directly on to the database native drivers 18-22 without further processing.

In one embodiment, the server computer or some other computer on a network between the server computer and the client computer contains cache storage control software as part of the Software 16 or 44. So, the connections to the databases 24-28 and the connections to Local Cache 30 may generally be connections over the same network or different networks where the cache storage control software may be locally stored on the Cache 30 and/or remotely stored at a server or another specific cache controlling computer coupled to the network. This cache storage control software, wherever installed, stores a query and/or results associated therewith in such a way that it can be returned at a later point without actually hitting the database. When caching such query data and/or results, this software can make the client computer believe that the data/results are coming from one or more backend databases when they are in fact coming from faster Cache locations. Meta data (types, filed names, etc.) may be stored, returned, and/or processed in the Cache in addition to the raw data requested by the query.

The client computer and/or another computer on the network may contain cache delivery software that provides the glue between the JDBC driver 16 (client) and Cache Storage 30 (located on a server or another computer). This glue code allows multiplexing of data and queries between Cache resources and the slower back-end database resources.

The server or another cache computer/server 30 within the system of FIGS. 1-2 contains cache management software. This software maintains the cache in an optimal and functional state by removing cached data as it become invalid, are changed on the main database, are swapped out to make more cache room, become too old, time-out, etc. Generally, there are three primary ways that caches are tagged as invalid: too old; data updated and internal event is triggered; and external script triggers an event that informs the manager to remove cache.

The system may also contain software intelligence routines on one or more computers, generally located within the Driver 16. These routines monitor and inspect queries for a given period of time on the system, and deduces which queries make the most sense to cache and which queries are best to pass on to the main databases.

The system may also contain system management software as part of the driver software 36. This software takes information from the Cache Intelligence component within the system and uses it to decide what queries should be cached and with what characteristics (i.e. the duration, replacement algorithm, etc.). The system may contain server management software as part of the client computer or Driver 16. This software maintains information that identifies which server among many different possible servers may contain a specific query cache. Large systems will likely have multiple servers for any one given query.

While the caching system, methodologies, constructs, and uses thereof are taught herein and are illustrated and described with reference to specific implementations, further modifications and improvements will occur to those skilled in the art. For example, the systems taught herein use Java as the primary implementation language. However, it is possible to implement the same structures and methods with other languages, such as C or C++. The system may enable data caching upon access of data, on a certain time of day or date (i.e., for backups), or on a user trigger event (access to a specific file may result in caching of related files). The Drivers discussed herein can be implemented on one host/server or distributed across multiple hosts/servers for scalability purposes. It is to be understood, therefore, that the claims should not be limited to the particular forms and embodiments illustrated herein and that it is intended that the appended claims cover all modifications that do not depart from the spirit and scope of this invention.

What is claimed is:

1. A database system that enables caching of data, the system comprising:
a front-end system comprising an applications and interfaces that provide queries within the database system;
a backend system comprises at least one database containing data;
cache storage; and
a virtual driver communicatively coupled between the front-end system and the backend system and adapted to communicate with the cache storage, the virtual driver comprising:
interface code that is adapted to receive queries from the front-end system
virtual cache drivers that are adapted to process queries received by the interface code when the interface code determines that the queries need access to data located on the cache storage; and
native drivers that are adapted to process queries received by the interface code when the interface code determines that the queries need access to data located within the backend systems.

2. The system of claim wherein the interface code is adapted to determine which of the two of the virtual cache drivers or native drivers and needed to process a given request wherein the interface code may determine that: (i) only the virtual cache driver is needed; (ii) only the native driver is needed; or (iii) that both the native driver and the virtual cache driver are needed to process the query.

3. The system of claim 1 wherein the cache storage comprises at least two cache layers where a first cache layer has a first data access time and a first storage size and the second cache layer has a second data access time that is greater than the first data access time and a second storage size that is greater than the first data storage size.

4. The system of claim 1 wherein the information within the cache storage is segmented into blocks and each block has a valid bit indicating whether or not the data within a block is valid or invalid, wherein the state of the valid bits are changed based on one or more of: (i) information indicating that information within the block does not match corresponding information in the backend system; or (ii) the time the information is present within the cache storage.

5. The system of claim 1 wherein the interface code starts to configure both the virtual cache drivers and the native drivers to process the query while making the determination of whether or not the drivers are needed, so that one or both of the virtual cache drivers and the native drivers are at least partially prepared to begin processing the query once the determination is made.

6. The system of claim 1 wherein one or more of connection information, driver information, user information, or password information for each query being processed within the virtual driver is queued within the system for later access if a connection to the backend system is needed for that query.

7. The system of claim 1 wherein backend system connection details between the backend system and the front-end system are cached as cached connection information under the control of the virtual driver, wherein the virtual driver may terminate and reform connections to the backend system using the cached connection information.

8. The system of claim 1 wherein the virtual driver is used to monitor query execution to create a historical system performance file.

9. The system of claim 1 wherein a driver object associated with a query is changed by the virtual driver to reference a portion of the virtual driver other than the native driver.

10. The system of claim 1 wherein the system comprises query monitoring software than monitors the queries and determines over time which types of queries should be subjected to caching and which types of queries should not be subject to caching.

11. A virtual driver stored within a memory of a computer, the virtual driver comprising:
application interface code, stored in memory, that is adapted to accept queries from an application and adapted to provide query data back to the application;
backend interface code, stored in memory, that is adapted to retrieve data from at least one backend database server and provide data out to the at least one backend database server;
virtual cache driver code, stored in memory, that is adapted to provide information to and from cache storage unit; and
control code, stored in memory, that is adapted to detect queries, determine whether the queries are to be processed through one or more of the backend interface code or the virtual cache driver code, and routing the query processing in accordance with that determination.

12. The virtual driver of claim 11 wherein the virtual driver contains query information that references native driver code associated with the backend database server, the virtual driver containing code to change the query information so that it references the virtual cache driver code and not the native driver code.

13. The virtual driver of claim 11 wherein the backend interface code and the virtual cache driver code communicate respectively with a backend system and the cache storage unit across the same network.

14. The virtual driver of claim 11 wherein cache code associated with the virtual driver monitors the contents of the cache storage as compared to the contents of a backend system and removes or invalidates cached data within the cache storage if that data: contains an error; has become invalid; does not match data within the backend system; has timed out; or is designated for replacement by other data.

15. The virtual driver of claim 11 wherein monitoring code associated with the virtual driver monitors incoming queries and their performance over time in order to determine optimal data and queries to process within the cache storage.

16. A method for caching content within a database system, the method comprising the steps of:
providing a query from an application through an application programming interface to a virtual driver;
processing the query within the virtual driver to determine if the query involves data cached within a local cache area or data within a backend database;
changing the query to enable the query to be performed using the local cache area if the query involves data cached within the local cache, else leaving the query in a form that accesses native drivers;
transferring the query for processing to either the local cache area or the native drivers and backend database as determined by the virtual driver; and
executing the query to obtain a result wherein the virtual driver is used to provide the result back to the application.

17. The method of claim 16 wherein a physical connection to the backend is not created until a determination is made that the backend database will be needed to process the query.

18. The method of claim 16 wherein a physical connection information and query information is stored in memory within the database system to enable the processing of multiple queries at a time within the database system.

19. The method of claim 16 wherein historical performance of queries is monitored in order to allow the database system to dynamically change what information is stored within the local cache area so that overall database system performance is improved.

20. The method of claim 16 wherein the average completion time for a query executed via the local cache area is at least 10× faster than the average completion time for a query executed via the backend database.
